(19) United States
(12) Patent Application Publication
(10) Pub. No.: US 2026/0030803 A1
(43) Pub. Date: Jan. 29, 2026

(54) LOCATION VISUALIZATION ON MAP

(71) Applicant: Snap Inc., Santa Monica, CA (US)

(72) Inventors: Nathan Kenneth Boyd, Los Angeles, CA (US); Brett Camper, Brooklyn, NY (US); Travis M. Grigsby, Seattle, WA (US); Kevin Kreiser, Annville, PA (US); Mengyao Li, Ho-Ho-Kus, NJ (US); Suraj Vindana Samaranayake, New York, NY (US); Kevin Joseph Thornberry, London (GB); Patrick Young, Denver, CO (US)

(21) Appl. No.: 18/785,090

(22) Filed: Jul. 26, 2024

(51) Int. Cl. G06T 11/20

(52) U.S. Cl. CPC G06T 11/203; G06T 2200/24; G06T 2210/12

(57) ABSTRACT

Described is a system for generation location visualization on a map interface by identifying a current location of a user that is initiating an interaction function of an interaction client; identifying a map corresponding to the current location of the user; identifying one or more map tiles associated with the map; receiving historical location data of the user that is associated with the current location of the user; converting the historical location data into an overall polygon that is comprised of a plurality of polygons based on the identified one or more map tiles; and displaying the map with the plurality of polygons on a user interface.

### TECHNICAL FIELD

The present disclosure relates generally to map interfaces, and more specifically to location visualization on a map interface.

### BACKGROUND

Maps in interaction platforms have evolved significantly, offering users interactive and personalized experiences. These maps are typically powered by user location data, which is collected through various means such as a global positioning system (GPS), check-ins, and shared activities. Such maps enable users to visualize their locations, see friends' locations, and discover new places based on popular trends and recommendations. These maps can also provide features such as real-time location sharing, directions to a certain location, and displaying points of interest such as nearby restaurants, creating an engaging and dynamic interface that enhances interaction, connectivity, and usefulness.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates an example method for generating location visualization on a map interface, according to some examples.

FIG. 5 illustrates a portion of the United States divided into tiles, according to some examples.

FIG. 6 illustrates a the division of a tile into sub-tiles, according to some examples.

FIG. 7 illustrates an aspect of the subject matter in accordance with one embodiment.

FIG. 8 illustrates map tiles with an overall polygon on a map, according to some examples.

FIG. 9 illustrates a user interface on an interaction client of a user avatar in a location displaying an overall polygon on a map as well as highlighting landmarks that touch the overall polygon, according to some examples.

FIG. 10 illustrates the functionality of setting specific parameters to generate and display overall polygons for a particular area, such as New York City, according to some examples.

FIG. 11 illustrates a user interface for highlighting points of interest (POIs) and displaying a user interface (UI) in three dimensions (3D), according to some examples.

FIG. 12 illustrates a zoomed-out view of the user interface (UI) of FIG. 10, according to some examples.

FIG. 13 is a zoomed-out view of the UI of FIG. 12, according to some examples.

FIG. 14 is a diagrammatic representation of a message, according to some examples.

FIG. 15 illustrates a system including a head-wearable apparatus with a selector input device, according to some examples.

FIG. 16 is a diagrammatic representation of a machine in the form of a computer system within which a set of instructions may be executed to cause the machine to perform any one or more of the methodologies discussed herein, according to some examples.

FIG. 17 is a block diagram showing a software architecture within which examples may be implemented.

FIG. 18 illustrates a machine-learning pipeline, according to some examples.

FIG. 19 illustrates training and use of a machine-learning program, according to some examples.

### DETAILED DESCRIPTION

Traditional systems for displaying user historical location data typically involve basic map interfaces that may show past locations as points or simple lines connecting points. These systems often provide limited interactivity and visualization capabilities, offering a static representation of where a user has been over time. Users can view their location history in a chronological or list format, sometimes with basic statistics like total distance traveled or places visited.

However, these traditional systems have several deficiencies. Firstly, they lack context and meaningful visualization beyond basic point data, making it difficult for users to derive insights or patterns from their location history. Secondly, they often do not integrate additional contextual information such as the type of location visited (e.g., parks, restaurants, workplaces) or the frequency of visits. This limits their usefulness in understanding user behavior or preferences based on location. Thirdly, traditional systems may not provide options for aggregating or summarizing data across different geographic scales (e.g., cities, states, countries), which is crucial for gaining insights into broader travel patterns or global interactions.

In summary, while traditional systems can display user historical location data to some extent, they are typically limited in terms of interactivity, visualization capabilities, context richness, and scalability across different geographic levels. These deficiencies highlight the need for more advanced and user-centric approaches to visualizing and interacting with location data, which the interaction system aims to address.

The interaction system described herein improves upon traditional systems by offering advanced features that address their deficiencies in displaying user historical location data. Unlike traditional point-based or simple line representations, the interaction system uses polygons to encapsulate areas where a user has spent time. This approach provides a more detailed and visually comprehensive representation of visited locations. By outlining areas rather than just points, the interaction system can convey spatial extent and coverage more effectively. Users can see clearly defined boundaries of places they have visited, enhancing their understanding of their travel patterns.

The interaction system integrates additional contextual information into the visualization process. Each polygon can be associated with metadata such as the type of location (e.g., parks, malls, landmarks) and the duration or frequency of visits. This contextual richness enables users to gain deeper insights into their behavior and preferences based on where they have been. For instance, users can easily distinguish between leisure areas and work locations, or identify favorite spots based on the frequency of visits.

Unlike static displays, the interaction system provides an interactive user interface where users can zoom in or out to view their historical locations at various geographic scales. This scalability allows users to explore their travels from a global perspective down to local details. For example, users can zoom out to see entire countries highlighted or zoom in to explore specific neighborhoods or landmarks within cities.

The interaction system supports real-time updates based on user activities and changing preferences. Users can customize how their historical data is visualized, such as adjusting the timeframe or filtering by types of locations. This personalization enhances user engagement and utility, as the system adapts to reflect their evolving travel patterns and interests over time.

In summary, the interaction system significantly enhances the way user historical location data is visualized and interacted with by overcoming the limitations of traditional systems. It provides a richer, more informative, and customizable experience that empowers users to better understand and manage their location histories.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in a polygon generation process. Computing resources used by one or more machines, databases, or networks may thus be more efficiently utilized or even reduced.

### Networked Computing Environment

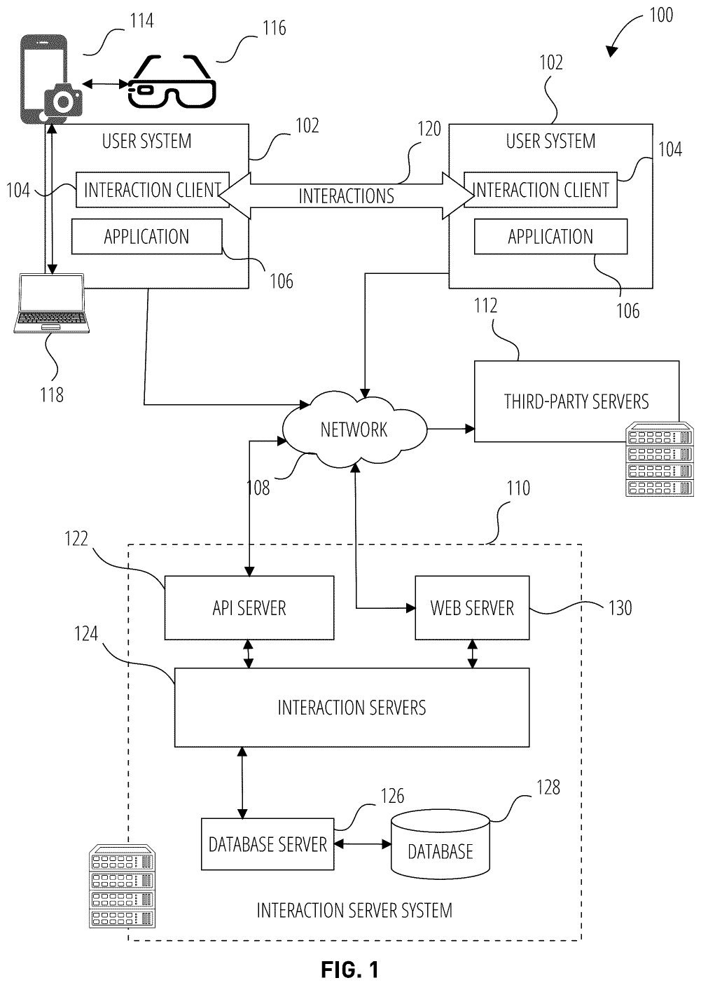

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

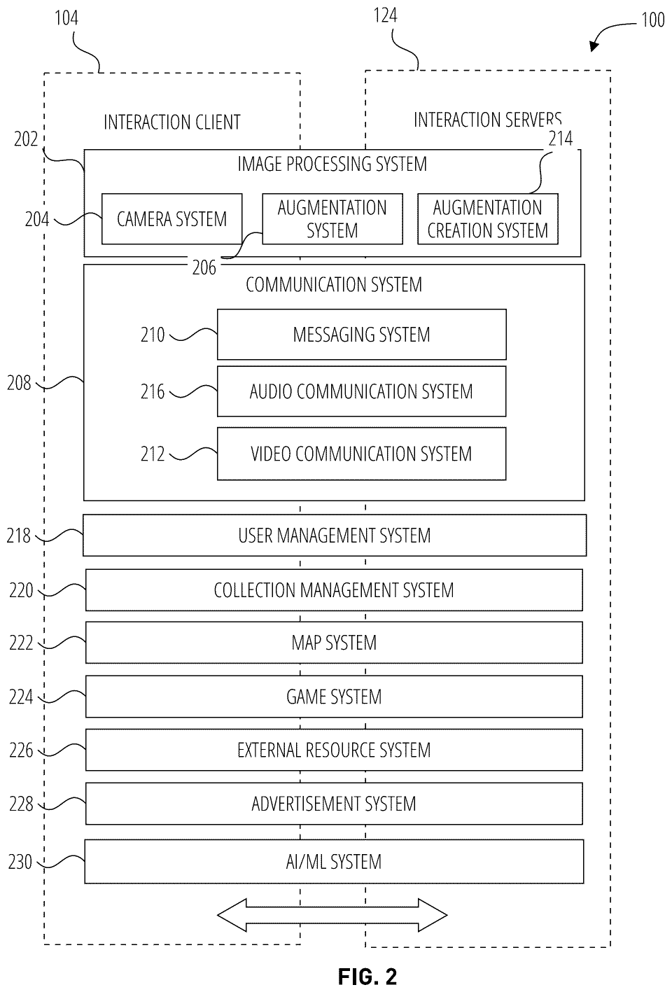

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 1502 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

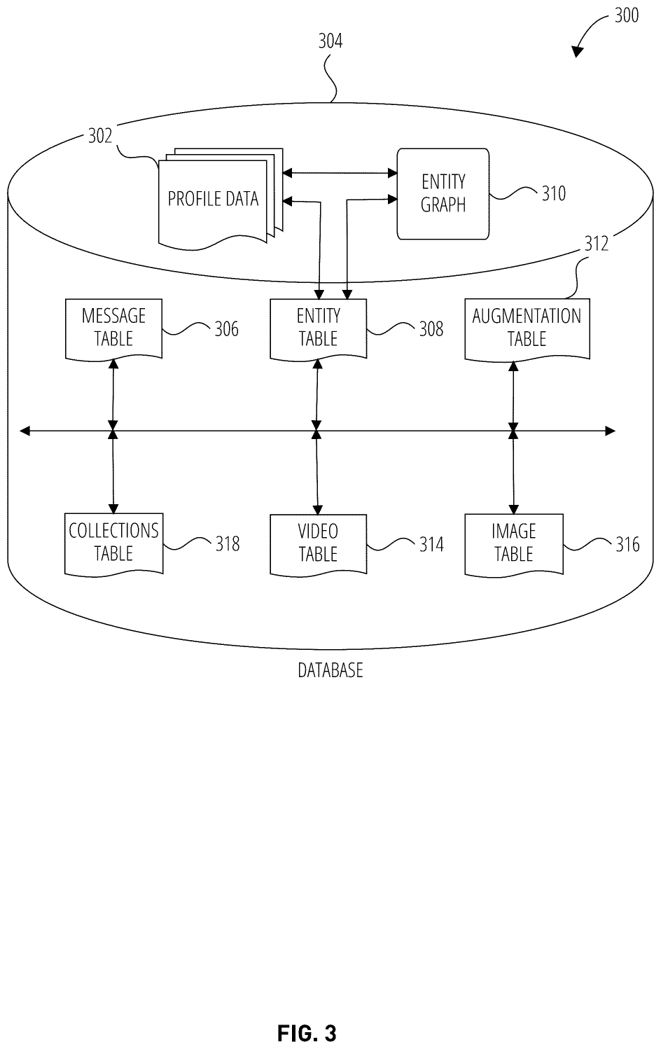

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, the system operating within the interaction client 104 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Location Visualization on a Map Interface

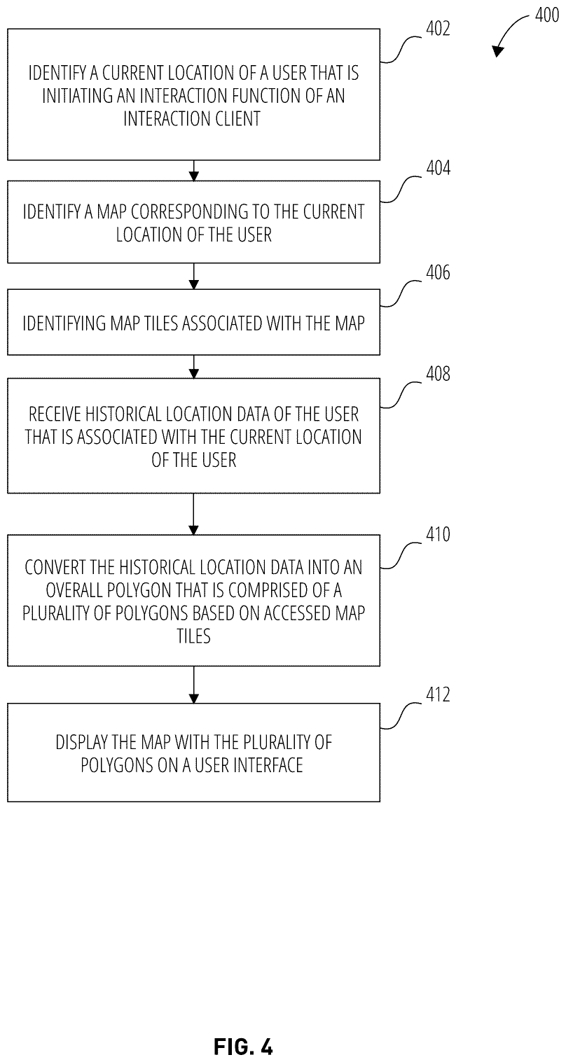

FIG. 4 illustrates an example method 400 for generating location visualization on a map interface, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

FIG. 4 is described as being performed by certain systems or applying certain processes, such as a particular machine learning model or computer vision model, but the processes described herein can be performed by one or more other or the same machine learning models, computer vision models, or a combination thereof.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

At operation 402, the interaction client identifies a current location of a user that is initiating an interaction function of an interaction client. A user initiates an interaction function within an interaction client. This interaction client could be an application or a service that provides mapping functionalities where the user might want to view their location history or share their location.

In some examples, interaction functions include user interaction with a camera feed displayed on the user system 102, such as selecting a real-world object on a camera feed or selecting a digital item or overlay shown on the camera feed. In some examples, interaction functions also include a chat window where messages, stickers, emojis, and other media content items are shared between users via user systems 102.

Interaction functions further include sending photos or videos to friends, either individually or in groups, which are edited with text, stickers, filters, and drawings before being sent. Interaction functions include capturing a video or audio, inputting text, or other communications that disappear after certain conditions are met, such as being viewed once or setting a time limit, creating a more ephemeral and casual sharing experience.

In some examples, interaction functions include generating or viewing a collection of videos, messages, stickers, or other media content items that are visible to friends for a certain period of hours (e.g., 24 hours). Interaction functions include displaying media content items from other users, such as publishers, creators, and influencers, where users explore and subscribe to different channels to receive updates on their favorite content. Interaction functions include map and location functions, such as users sharing their location with friends and viewing their friends' locations on a map, or exploring a map with points of interest by other users categorized by location and events.

In some examples, interaction functions include generating or applying various filters and content augmentations to enhance images, videos, or other media content items to share with others, such as by adjusting the color or appearance or adding interactive elements such as animations and facial transformations, in real-time. Interaction functions include saving favorite media content items with other users in a private archive, where users access these saved media content items later, edit them, or share them with friends.

Interaction functions include personalizing or applying avatars which are used as a profile picture to be viewed by others and in stickers, chat, and image/video decorations. Interaction functions include playing multiplayer games that users play with their friends directly within the user interface of the system to share messages and media content items.

Interaction functions include capturing data by an Augmented Reality (AR) device. In some examples, the interaction system 100 captures motion and position data, such as data from accelerometers, gyroscopes, and magnetometers to track user movement or orientation. In some examples, the interaction system 100 captures eye-tracking data which monitors the user's eye movements and focus, gaze-based interactions, objects the user is focused (or not focused) on, or user attention patterns.

In some examples, the interaction system 100 captures facial expressions. In some examples, the interaction system 100 captures biometric data, such as heart rate, body temperature, or skin conductivity. In some examples, the interaction system 100 captures data related to user interactions within the virtual or augmented environment, such as objects or buttons users interact with, the time spent in specific areas, or the choices users make. In some examples, the interaction system 100 captures voice data, voice recognition, voice commands, and/or the like. In some examples, the interaction system 100 captures location data, such as a user's GPS location. In some examples, the interaction system 100 captures usage data related to how and when the devices are used, session duration, frequency of use, and user engagement with specific content or applications.

When the user initiates this interaction function, the interaction client opens a map interface, starting a location-sharing session, or other interaction that involves user location data.

The interaction client accesses the device's sensors to determine the current location of the user. The interaction data can use GPS (Global Positioning System), or other location-determining technologies such as Wi-Fi positioning, cell tower triangulation, or Bluetooth beacons.

In some cases, the interaction system collects raw location data, which may include latitude, longitude, altitude, and additional contextual information such as the time of the location fix, the accuracy of the data, and the speed and direction of the user if they are moving.

The raw location data is processed to determine a precise current location of the user, such as by filtering out noise or errors in the data, combining data from multiple sensors for improved accuracy, and applying corrections based on known factors like map data. The processed data is then used to pinpoint the user's current location. This location is can be represented as a set of coordinates (latitude and longitude) on the map.

In some cases, additional contextual information might be determined alongside the current location. For instance, the system might recognize that the user is indoors, near a specific landmark, or in a certain type of area (e.g., urban, suburban, rural).

In some cases, the interaction client includes an extended reality device or communicates with an extended reality device, where the extended reality device provides the current location of the user.

At operation 404, the interaction client identifies a map corresponding to the current location of the user. The interaction client accesses a database of maps. This database can be a local cache within the interaction client or a remote server storing detailed map information.

The interaction client determines the map boundaries that encompass the user's current location. The interaction client identifies the specific geographic area that needs to be displayed based on the user's coordinates.

Depending on the zoom level and the detail level, the interaction client selects an appropriate map scale. For instance, a city-level map might be chosen for a higher zoom level, while a neighborhood-level map might be used for a lower zoom level.

At operation 406, the interaction client identifies map tiles associated with the map. The interaction client divides the world map into a grid of map tiles, each covering a specific geographic area. The interaction client identifies which map tiles correspond to the user's current location. The interaction client determining which tile(s) the user's coordinates fall into.

The interaction client fetches the relevant map tiles from the database. These tiles include the visual data necessary to display the map, including roads, landmarks, buildings, and other geographic features.

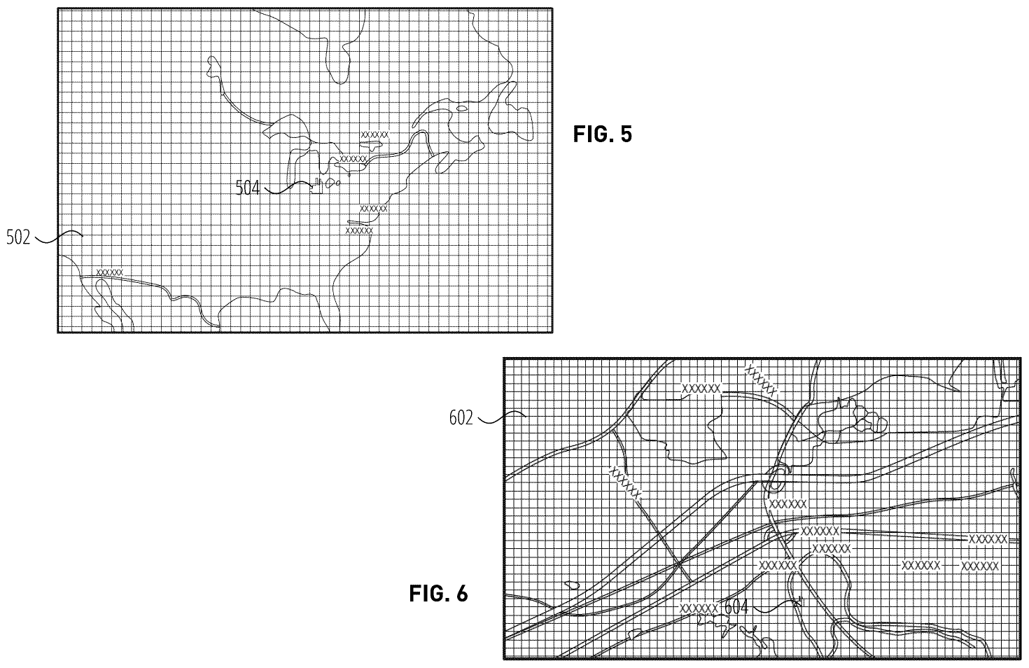

FIG. 5 illustrates a portion of the United States divided into tiles, according to some examples. The interaction system identifies a portion of the world that corresponds to a user's location 504. The interaction system divides the world into tiles 502 that allows for efficient storage, retrieval, and display of geographic information on digital maps. The world map is divided into a grid of large, equal-sized square tiles. The interaction system maps the globe onto a flat, rectangular surface. The tiles can cover certain range, such as 150,000×150,000 meters.

FIG. 6 illustrates a the division of a tile into sub-tiles, according to some examples. The interaction system can identify the tile that the user's current location is associated with. Each of the large tiles can be further divided into smaller tiles 602, called sub-tiles. The interaction system can further identify the relevant sub-tiles for the user's current location 604, such as nearby tiles that fit the number of tiles in width and length for the user interface.

For instance, a 150,000×150,000 meter tile can be divided into a grid of 10×10 smaller tiles, each 15,000×15,000 meters. This process can continue, with each sub-tile being divided into even smaller sub-tiles. Each level of division increases the granularity and detail of the map. The sub-tiles can be indexed using a quadtree or similar data structure, which allows for efficient access and management.

This hierarchical tiling system offers several advantages. It allows for efficient data storage and retrieval because the map data can be loaded and displayed at different levels of detail as needed. When a user zooms in on a map, the system can load higher resolution sub-tiles, while zooming out triggers the loading of larger, less detailed tiles. This approach also reduces the amount of data that needs to be transmitted and processed at any given time, improving performance and responsiveness.

The tiles are stored in a database with a unique identifier for each tile, such as based on its level in the hierarchy and its position within the grid. When a user's location or map view changes, the interaction client calculates which tiles are needed to fill the viewport, retrieves them from the database, and assembles them into a seamless map display.

By dividing the world into tiles and progressively into smaller sub-tiles and sub-sub tiles, digital mapping systems can efficiently manage and display vast amounts of geographic data, providing users with detailed, scalable maps that are tailored to their current location and zoom level.

To ensure efficient display and smooth user experience, the interaction client may also fetch additional tiles surrounding the user's location. This pre-fetching helps in panning and zooming operations by reducing the need for real-time data fetching.

At operation 408, the interaction client receives historical location data of the user that is associated with the current location of the user. The interaction system uses this data for understanding the user's past movements and activities in the vicinity of their current location or in remote locations.

When the user interacts with the map or a related feature in the interaction client (such as opening the application (app) or requesting to see their location history), the interaction client initiates a process to fetch relevant historical location data. This can be triggered by the user's action, such as zooming into a specific area on the map or requesting a historical view of their movements.

The interaction client sends a query to a server or a local database that stores the user's historical location data. This database can include time-stamped records of the user's past locations, which may include specific coordinates, timestamps, and possibly additional context (such as activities performed or places visited).

The interaction system filters historical location data to find records that are geographically close to the user's current location. This can involve spatial queries that select data points within a certain radius or bounding box around the current location. The radius or bounding box can be dynamically adjusted based on the zoom level or specific user requests.

The interaction system can access historical location data of a user via user interaction with features of the interaction system. In some cases, the interaction system only uses internal historical location data of a user based on the user's interactions with internal features of the interaction system. In some cases, the interaction system accesses historical location data across multiple interaction clients of the same interaction system, such as a mobile phone, a smart watch, and an AR or VR device that all have the same app of the interaction system.

In some cases, the interaction system accesses one or more third party data sources that track and store geographic information. These sources can include user-generated content, app-based location tracking, and data collected by various service providers.

The interaction system can access user-generated content on social media or interaction platforms. Users often check in to locations or tag their photos and posts with geographic information. For example, when a user checks in at a restaurant, tags a photo with a location, or adds a location sticker to a story, this data is stored by the respective interaction platform. The interaction system can access this data through APIs provided by these platforms, aggregating it to create a comprehensive history of the user's movements and activities.

The interaction system can access data from mobile apps that track and store location data as part of their functionality. Fitness tracking apps, weather apps that use location to provide forecasts, and navigation services collect detailed location data. Additionally, ride-sharing applicant submits store records of users' rides and trips. By integrating with these apps, the interaction system can retrieve historical location data to enhance the user's location history.

The interaction system can access data from telecommunication providers collect location data through cell tower connections and mobile network usage, which can be used to infer a user's location over time. This data can be accessed through partnerships with mobile carriers or third-party data aggregators. Similarly, public Wi-Fi networks and in-store Wi-Fi can provide location data based on the user's connections to these networks. Retailers can also contribute data through purchase history and loyalty program interactions, offering insights into the locations the user frequents.

The interaction system can access data from smart home devices such as thermostats, security systems with geofencing capabilities, and IoT devices which track and report location data. For example, a smart thermostat might record when the user is home or away, while a home security system can log entries and exits. This data can be accessed through integrations with smart home platforms, providing additional context to the user's location history.

The interaction system can access data from financial services databases that may collect location data through ATM transactions, credit card purchases, and mobile banking apps. This data provides valuable insights into the user's whereabouts at specific times and activities. Additionally, travel and booking services collect data from travel itineraries, hotel bookings, and flight histories. This information can be used to track the user's movements across different regions and countries.

The interaction system can access third-party data aggregators that compile location data from various sources, including ads served on mobile devices and location-based gaming apps.

Having access to historical location data allows the interaction system to create an overall polygon representing the user's movements and visited locations even when the user first enables the Footsteps feature. By leveraging the comprehensive historical data collected from various sources such as social media check-ins, app-based tracking, telecommunication records, smart devices, financial transactions, and third-party aggregators, the system can instantly generate a personalized map. This map, composed of multiple polygons, provides an accurate and detailed visualization of the user's past activities and movements, ensuring an immediate and meaningful user experience from the moment the feature is activated.

Handling historical location data involves significant privacy considerations. The interaction client ensures that data is stored securely and that access is restricted to authorized users. The transmission of historical location data between the server and the interaction client is encrypted to prevent unauthorized access. The system also implements robust authentication and authorization mechanisms to protect user data.

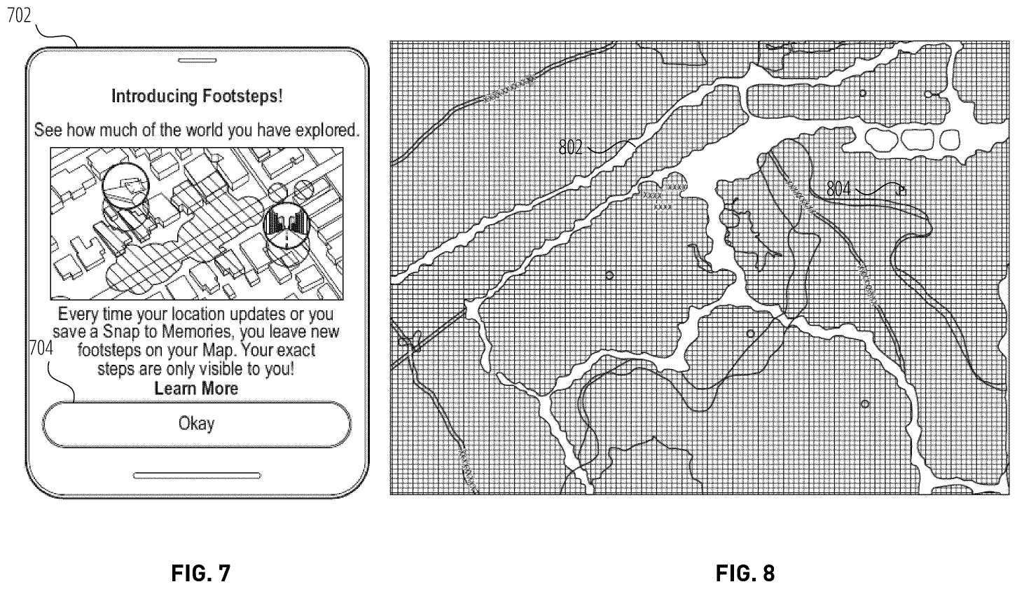

FIG. 7 illustrates a user interface for opting in to the use of historical location data, according to some examples. The interaction system displays a user interface for opting into the visual map feature and to the use of historical location data.

When the user opens the app, the interaction system displays an introduction screen 702 that explains what the Footsteps feature is and how it works. The user interface provides a more detailed information about data usage and privacy, an explanation of the types of location data that will be collected (e.g., GPS coordinates, Wi-Fi signals), details on how the historical location data will be used to create personalized maps and visualizations, and information on data security measures, user privacy protection, and compliance with data protection laws.

The user interface includes a user selectable opt-in element 704 for the user to actively opt-in to the feature. In some cases, the user interface includes a checkbox or toggle to allow the app to collect historical location data. In some cases, the interaction system requests permission to access location services and/or sharing of any location data to others.

At operation 410, the interaction client converts the historical location data into a polygon (such as an overall polygon), and/or adds the polygon in the place of the tile. The overall polygon can be comprised of a plurality of polygons.

The interaction client transforms historical location data into a visual representation (polygon) on a map that highlights the areas a user has explored. The historical location data points are mapped onto the grid. Each data point is assigned to the corresponding tile or sub-tile based on its geographical coordinates.

The interaction client converts the tiles (or sub-tiles) containing historical data points into polygons. Each tile or sub-tile with user activity becomes a polygon, such as a circle. For each tile or sub-tile, a polygon is created to represent the area. The shape and size of the polygon can be adjusted to fit the tile boundaries.

To smooth the visual representation, overlapping between adjacent tiles can be introduced. Additionally, a slight jitter can be applied to the edges to avoid rigid, grid-like appearances. The map tiles overlap with each other, and the plurality of polygons that are adjacent to each other overlap with one another.

The individual polygons formed from the tiles and sub-tiles are combined to create the overall polygon. This involves merging the polygons into a single, cohesive shape. The edges of the combined polygon are smoothed to create a visually appealing shape. Refinement techniques can adjust the polygon to better fit the underlying geographical features.

The final overall polygon, representing the areas the user has explored, is displayed on the map. The polygon can be dynamic, updating as new historical location data is collected. Users can customize the appearance of the polygon, such as changing its color, opacity, and other visual attributes.

As an example, a user has visited multiple locations in a city over the past month. The historical location data points are scattered across different areas of the city. The interaction client processes this data, mapping each point to a corresponding tile on the city's map. Each tile with user activity becomes a polygon, and these polygons are merged into an overall polygon that outlines the user's explored areas. The resulting polygon is displayed on the map, with notable landmarks highlighted in 3D.

FIG. 8 illustrates map tiles with an overall polygon on a map, according to some examples. The figure illustrates a map divided into a grid of tiles, each representing a specific geographic area.

Each tile (or sub-tile) where the user has been is marked, and these markings are combined to form multiple overlapping polygons. These individual polygons, based on the user's historical location data, are then combined to create an overall polygon 802 that represents the comprehensive area the user has explored. This overall polygon is shaded or colored to distinguish it from other areas on the map, providing a clear visual summary of the user's movements and visited locations.

Additionally, the diagram includes a marker 804 indicating the user's current location, providing context for the user's position relative to the historical data. This marker can be a distinct symbol, such as a pin or dot, and is highlighted in a different color to stand out from the polygons and tiles. The map might also feature interactive elements like zoom controls and labels for better navigation and interpretation.

The overall polygon, formed from the overlapping individual polygons, showcases the extent of the user's travels, while the current location marker allows the user to see their real-time position within the broader context of their historical movements. This visual representation helps users easily understand their travel patterns and how they relate to their current location.

In some cases, the interaction client generates an overall polygon based on historical data using a machine learning model based on historical location data. This data includes timestamps and coordinates of the user's past visits to various places.

The machine learning model can be trained to identify patterns and clusters within the user's location history. These clusters help in defining areas or zones where the user has spent significant time.

Next, the model can generate polygons by creating boundaries around these clusters of points. For example, the interaction system can apply convex hull algorithms to create basic polygons around clustered points. In other cases, the interaction system can apply polygon tessellation or machine learning techniques that learn to predict polygon shapes based on historical movement patterns and spatial relationships.

To improve accuracy, the model may incorporate additional features such as visit frequency, visit recency, and time spent at each location. These features provide context and weighting to the polygons generated. For example, areas where the user has visited frequently or spent more time may be represented with larger or more detailed polygons, while less frequented locations may have smaller or simpler shapes.

Finally, the generated polygons are overlaid onto a map in the user interface, providing a visual representation of the user's movement history. This visualization not only helps users track their past activities but also enables them to explore patterns and trends in their location data. Machine learning plays a crucial role in automating this process, making it scalable and adaptable to different users' location histories and preferences.

At operation 412, the interaction client displays the map with the plurality of polygons on a user interface. The interaction client renders a map where the user's visited locations are visually represented by a plurality of polygons.

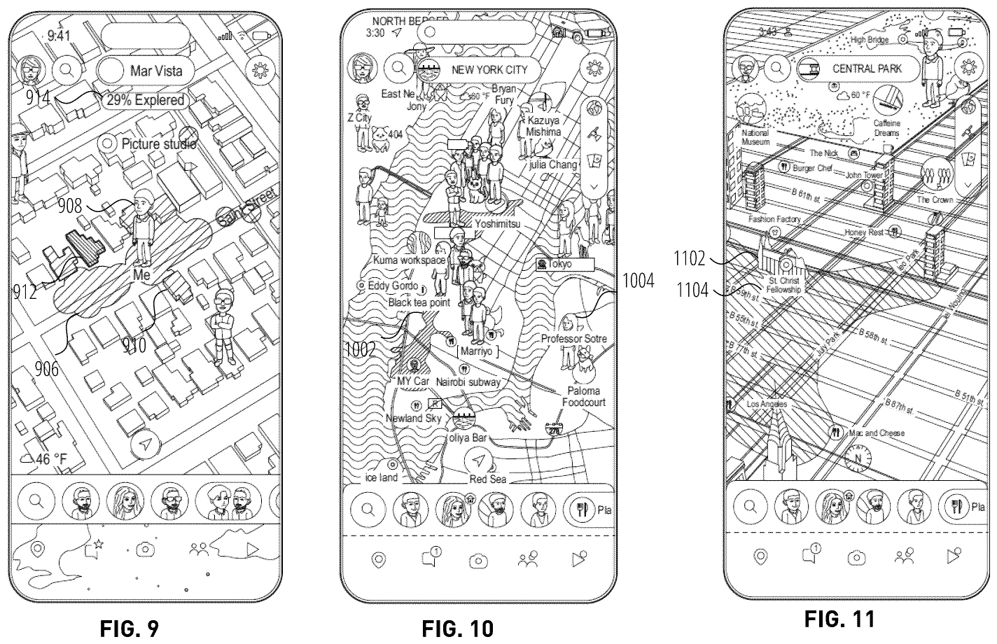

FIG. 9 illustrates a user interface on an interaction client of a user avatar in a location displaying an overall polygon on a map as well as highlighting landmarks that touch the overall polygon, according to some examples. The map displays an overall polygon 906, which encapsulates the areas the user has previously visited. This polygon is formed by combining multiple overlapping polygons derived from the user's historical location data.

The overall polygon is visually distinct, can be shaded or colored differently to stand out against the map's background, making it easy for the user to identify the extent of their past movements. This comprehensive representation helps users quickly grasp the areas they've explored over time.

In addition to the overall polygon, FIG. 9 also highlights various landmarks that intersect with or touch the polygon. These landmarks are visually marked and labeled, providing context and points of interest within the explored areas. The landmarks could include buildings (such as building 910), parks, monuments, or other significant locations that the user has visited or passed by.

By highlighting these landmarks, the interface enhances the user's understanding of their travel patterns and the notable sites they've encountered. This feature not only adds an informative layer to the map but also personalizes the user's experience, allowing them to recall memories associated with specific landmarks within the overall polygon.

FIG. 9 further illustrates that a user's avatar 908 can be displayed on the map within the user interface, providing a personalized touch to the visualization. The avatar represents the user's current or historical position and moves dynamically as the user navigates through the map. This feature helps users easily identify their location in relation to the overall polygon and highlighted landmarks.

The polygons are overlaid on a basemap, providing a clear and detailed view of the areas the user has explored. The polygons can be rendered accurately and efficiently, taking into account factors like map scale, resolution, and user device capabilities. The interaction client may use vector graphics to draw the polygons, allowing for smooth zooming and panning without loss of detail. Additionally, the UI design is tailored to make the visualization intuitive, using color coding, transparency, and other visual cues to differentiate between various areas and levels of user activity.

The interaction client can display various statistics related to the overall polygons on the map interface, providing users with insightful metrics about their location history. For example, one statistic is the percentage of area covered for a specified region 914, such as a city, state, or particular area like a park, field, or event location. This statistic indicates how much of the total area of the region the user has explored, represented as a percentage of the entire region's area.

Additionally, these statistics are dynamically linked with the zoom level of the map. As users zoom in or out, the displayed percentage adjusts to reflect the area covered within the current zoomed region versus the total area of that zoomed region. This allows users to gain detailed insights at various scales, from broad overviews to specific, localized coverage, enhancing their understanding of their exploration patterns within different geographical contexts.

To implement the percentage of area covered in a region, the interaction system can dynamically vary the color of the highlight based on several factors. Firstly, the interaction system can adjust the color intensity or hue of the highlighted area on the map based on the percentage of the total area covered by the polygons representing user visits. For instance, areas with a higher percentage covered can be displayed in a more saturated color or a different hue to distinguish them from less frequently visited areas. This visual differentiation helps users quickly understand where they have spent more time or visited more frequently within a region.

Additionally, you can vary the color of the highlight based on the recency of visits. Recent visits can be highlighted in a brighter or more prominent color, such as building 912, whereas older visits may be displayed in a more muted tone. This approach allows users to casily identify where they have been recently versus places they visited longer ago.

Moreover, varying the color based on visit count provides another layer of information. Areas with more visits can be highlighted in a specific color, while less visited areas can be represented differently, providing a visual summary of the user's activity density across different parts of the region. These color variations enhance the user interface's usability by visually summarizing visit patterns and activity levels effectively.

In some cases, the interaction client ensures polygons conform to underlying map features helps maintain accuracy and relevance. For instance, keeping polygons aligned with roads rather than bleeding into nearby buildings on the street enhances spatial fidelity and usability.

In some cases, the interaction client measure linear coverage using the polygons more effectively than individual points. This capability allows for a more nuanced understanding of user trajectories and spatial patterns, providing insights into movement along specific routes or paths.

In some cases, the interaction client analyzes time spent and coverage within various map polygons, such as forests or parks, offers valuable insights into user behaviors and preferences. This data can help infer user lifestyles (e.g., outdoorsy activities) and understand temporal patterns (e.g., daytime versus after-work visits), enhancing personalized experiences and recommendations.

### Polygons for a Certain Area or a Time Frame

FIG. 10 illustrates the functionality of setting specific parameters to generate and display overall polygons for a particular area, such as New York City, according to some examples. The figure shows how users can customize the visualization of their location data by defining a time frame or specific area of interest. For instance, a user can set a particular date range, such as the past year, to see where they have been within that period. The interface allows for the selection of precise dates, such as the date and time when a plane landed or departed, providing a detailed view of the user's travel history.

Additionally, FIG. 10 demonstrates the ability to set a timer for real-time tracking or retrospective analysis, enabling users to see how their movement patterns have evolved over time.

Users can also specify geographical boundaries, such as a particular city or region, to narrow down the areas displayed on the map. This level of customization enhances the user experience by providing tailored insights into their location history, making it easy to visualize and understand their movements within a defined context.

In FIG. 10, the interface extends its functionality by allowing multiple users to have their own overall polygons displayed on the map. This means that alongside or in replacement of the user's own polygon, the map can also show one or more polygons representing the historical location data of other users within the same area. Each user's overall polygon is a distinct shape on the map, uniquely color-coded or styled to differentiate between users.

For example, a user can select another user's avatar 1004 and display that other user's overall polygon 1002 on the user interface. The user interface provides the ability to select and view the avatars of other users in the area. When a user selects a specific avatar, the interface highlights the corresponding overall polygon of that selected user.

This feature enables users to compare their movement patterns with those of others, facilitating social interactions or collaborative exploration. For instance, users can see where their friends have been over a particular time frame or within a specific geographical boundary, such as New York City. The ability to visualize multiple users' polygons enhances the social and interactive aspects of the map, providing a comprehensive and communal view of location history.

In some cases, the sharing of overall polygons on the map interface requires explicit opt-in consent from the user whose location data is being shared. This ensures user privacy and control over personal information. When a user opts in, their historical location data is converted into polygons and displayed on the map for others to view. The opt-in process includes clear prompts and settings where users can choose the extent of their data sharing, such as specific time frames or geographical boundaries. This consent mechanism ensures that users are fully aware and agreeable to their location history being visualized and shared with others on the platform.

In some cases, the other users are other users of the interaction system in the surrounding area. In other cases, the other users can be a listing of friends, a listing of historical chats between the first user and other users, other users from a phone book, missed calls, received calls, call history, and/or the like.

In some examples, other users that are associated with the user (such as within an interaction function of the interactive system) include followers or friends, where users can follow or be followed by others, or form some form of relationship such that other users can see certain information, such as each other's posts on their feeds. In some examples, the other users can include “close” or “best” friends that can create a relationship to share additional information not available to others, such as private posts, targeted sharing of content, and/or the like.

In some examples, other users are users mentioned or tagged in the user's posts, comments, chat messages, or other communication that draws the attention of the tagged user and/or can initiate conversations or discussions. In some examples, other users are users that are involved in a message chat with the user, such as a private messaging feature that allows users to send messages directly to one another or group chats among many users.

In some examples, other users are users that joined a group based on shared interests or common goals. Within these groups, users can interact and form relationships based on the group's focus and/or share information among group members. In some examples, other users are users who express support for users, such as through likes, comments, or shares, or vice versa. In some examples, other users are influencers or brand ambassadors that have established large followings and are seen as authorities or trendsetters in their niches. In some examples, other users are collaborators working together on projects or create content together.

Users can gain valuable insights into their habits and preferences by viewing their historical location data. For example, they can see which areas they visit most often, how their travel patterns change over time, and how much time they spend in different places.

Historical location data can also be used to provide personalized recommendations for places to visit, activities to try, or routes to take. For example, if a user frequently visits a particular type of restaurant, the app can recommend similar restaurants nearby.

The interaction client enables users to compare their location histories and interactions with others in meaningful ways, fostering connections based on shared experiences. The interaction client aggregates polygons between users and provides suggestions such as eliminating places they've both visited or suggesting new locations they haven't explored together yet, facilitating potential meetups. On a larger scale, the The interaction client generates heatmaps that highlight popular places and illustrate how their popularity changes over time, offering insights into seasonal variations and evolving trends.

The The interaction client can predict the easiest places for users to overlap based on their historical trajectories and preferences, enhancing social planning and interaction possibilities. The interaction client counts visits to specific locations allows for the creation of user popularity heatmaps, providing insights into foot traffic patterns and storefront values that could benefit vendors, realtors, and urban planners.

The interaction client integrates overall polygons with map features such as Points of Interest (POIs) and land cover provides personalized insights into user behavior, such as identifying interests or frequent visitation patterns. The interaction client overlays overall polygons with road data distinguishes between car drivers, pedestrians, and cyclists, offering insights into transportation choices and activity modes.

The interaction client correlates footsteps with news or current events enhances contextual understanding, allowing users to link their movements with significant developments in their surroundings. The interaction client suggests friends based on footprint overlaps helps users connect with others who share similar interests and activities, fostering community engagement and social networking.

### User Interface for Points of Interest in 3D

FIG. 11 illustrates a user interface for highlighting points of interest (POIs) and displaying a user interface (UI) in three dimensions (3D), according to some examples. For example, the map can be displayed on a mobile phone in 3D or on a AR/VR device.

In some cases, the interaction system accesses spatial databases or uses mapping APIs to access POI data such as landmarks, businesses, or attractions. Each POI is geolocated and represented as a point or area on the map or virtual environment. For example, a cathedral 1102 and its name 1104 is displayed.

In AR/VR settings, POIs can be visually differentiated using markers, icons, or labels that overlay on the user's view. These visual cues help users identify relevant POIs easily.

In mapping applications or AR/VR environments, users can engage with Points of Interest (POIs) by tapping on them or selecting them using touch or gesture controls. This interaction typically prompts the display of relevant details such as user reviews, business hours, or directions, enhancing the user's understanding and ability to navigate to the selected POI.

POIs are highlighted to draw attention to them based on factors like proximity to the user's current location or alignment with their specified preferences. In dynamic highlighting, the visibility of POIs may change as users interact with the environment or adjust their preferences, ensuring that the most relevant information is readily accessible. Augmented Reality (AR) and Virtual Reality (VR) devices utilize sensors such as cameras and depth sensors to scan and map the physical environment or a virtual space. This mapping process generates a spatial map that provides the device with information about surfaces, objects, and spatial relationships, enabling realistic overlays and interactions in AR and VR applications.

In AR applications, UI elements like menus, buttons, and information panels are integrated into the spatial map generated by the device. These elements appear overlaid on the user's view through the device's camera, appearing anchored to real-world objects or specific locations in the virtual environment. This integration allows users to interact with digital content seamlessly overlaid on their physical surroundings.

The user interface (UI) in AR/VR environments can dynamically update to reflect changes in the user's interactions or the surrounding environment. For instance, UI elements may adjust in response to user gestures, updated POI information, or changes in navigation routes. Real-time updates ensure that users receive current and relevant information, enhancing the usability and responsiveness of AR/VR applications.

Within the overall polygon, specific points of interest (e.g., buildings, landmarks) can be highlighted. These points can be emphasized to provide context and additional information about the explored areas. Buildings and landmarks can be rendered in 3D to enhance the visual representation and make the map more interactive.

### Overall Polygon Changes Via Map Zoom

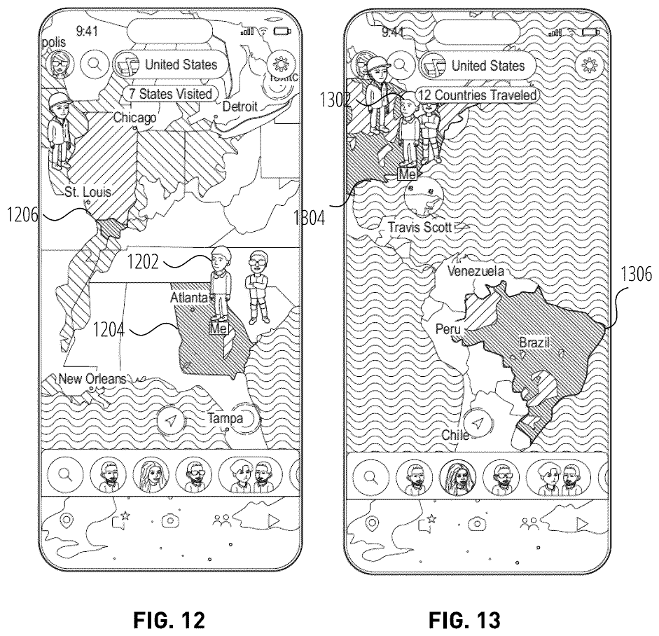

FIGS. 12 and 13 illustrate the updating of the overall polygon based on map zoom, according to some examples. In some cases, the interaction system updates an overall polygon based on historical data and changing zoom levels on a map via dynamic adjustments to accurately reflect a user's visited locations across different scales.

FIG. 12 illustrates a zoomed-out view of the user interface (UI) of FIG. 10, according to some examples. The figure features the current user's avatar 1202 displayed on a map of the United States. Additionally, the figure highlights two overall polygons: one over the state of Georgia 1204 and another over the state of Illinois 1206. These polygons indicate that the user has visited these states, providing a visual representation of the areas where the user has been active or has historical location data.

FIG. 13 is a zoomed-out view of the UI of FIG. 12, according to some examples. The user is depicted within the context of a map centered around middle America via a user avatar 1302, although the map extends to show a broader view including parts of the United States and Brazil. The overall polygons in this zoomed-out view are highlighted to represent political boundaries, specifically showing the entire USA 1304 and Brazil 1306. This visualization indicates that the user has visited these two countries, providing a macro-level perspective on the user's travel or location history across different national boundaries.

Machine learning models can facilitate this by continuously analyzing historical location data and responding to user interactions with the map.

At a higher zoom level, where more detail is visible, the model may adjust the polygons to show smaller, more precise areas where the user has visited frequently or spent more time. This requires the model to recalibrate the boundaries of existing polygons or generate new ones based on finer details in the location data.

Conversely, when zooming out to a broader view, the model aggregates polygons or simplify them to represent larger regions where the user has been active. This adaptation ensures that the visualization remains meaningful and comprehensible across different levels of granularity on the map.

To achieve this dynamic updating, the machine learning model leverages algorithms that are capable of real-time processing and adjustment of polygonal representations. These algorithms can take into account factors such as the density of location points within a given area, the frequency of visits over time, and the temporal aspects of user activity patterns. By continuously updating the polygons based on both historical data and real-time user interactions, the model provides an interactive and responsive visualization of the user's location history on the map. This capability not only enhances user experience but also supports applications in various domains, including location-based services, travel planning, and personal analytics.

Systems and methods described herein include training a machine learning net work, such as training to generate or update an overall polygon. The machine learning network can be trained to identify historical location data and generate the overall polygon, as well as updating the overall polygon based on updated location data of the user. The machine learning algorithm can be trained using historical information that include historical location data, and resulting overall polygons generated by other means, such as those generated herein.

Training of models, such as artificial intelligence models, is necessarily rooted in computer technology, and improves modeling technology by using training data to train such models and thereafter applying the models to new inputs to make inferences on the new inputs. Here, the new inputs can be historical location data of a new user. The trained machine learning model can determine an overall polygon for that new user.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new historical location data) and make predictions that the model was trained for based on the weights or scores that were adjusted during training. Such training of the machine learning models described herein reduces false positives and increases the performance.

### Data Communications Architecture

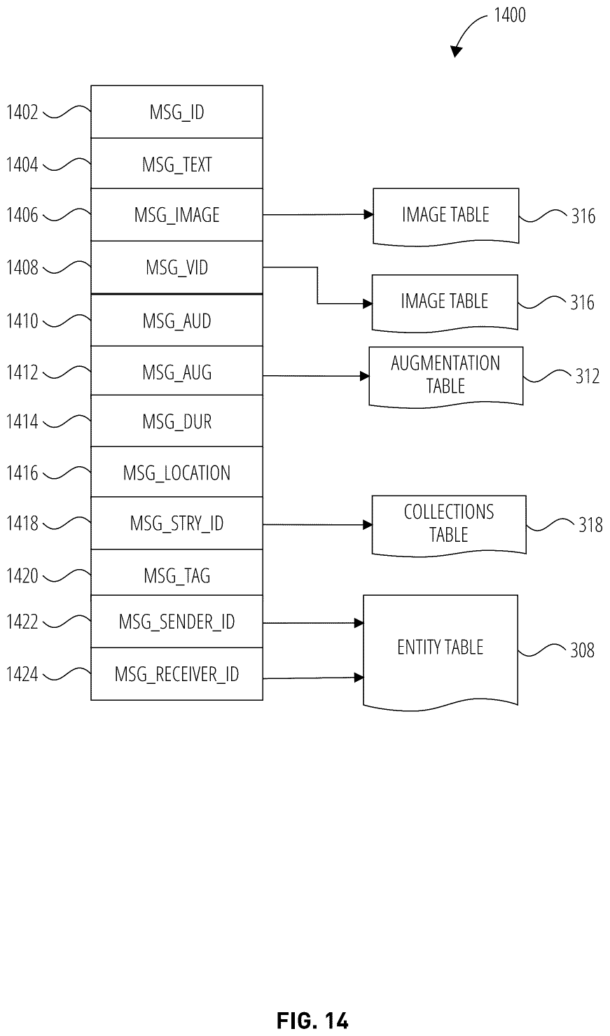

FIG. 14 is a schematic diagram illustrating a structure of a message 1400, according to some examples, generated by an interaction client 104 for communication to a further interaction client 104 via the interaction servers 124. The content of a particular message 1400 is used to populate the message table 306 stored within the database 304, accessible by the interaction servers 124. Similarly, the content of a message 1400 is stored in memory as “in-transit” or “in-flight” data of the user system 102 or the interaction servers 124. A message 1400 is shown to include the following example components:
Message identifier 1402: a unique identifier that identifies the message 1400.
Message text payload 1404: text, to be generated by a user via a user interface of the user system 102, and that is included in the message 1400.
Message image payload 1406: image data, captured by a camera component of a user system 102 or retrieved from a memory component of a user system 102, and that is included in the message 1400. Image data for a sent or received message 1400 may be stored in the image table 316.
Message video payload 1408: video data, captured by a camera component or retrieved from a memory component of the user system 102, and that is included in the message 1400. Video data for a sent or received message 1400 may be stored in the image table 316.
Message audio payload 1410: audio data, captured by a microphone or retrieved from a memory component of the user system 102, and that is included in the message 1400.
Message augmentation data 1412: augmentation data (e.g., filters, stickers, or other annotations or enhancements) that represents augmentations to be applied to message image payload 1406, message video payload 1408, or message audio payload 1410 of the message 1400. Augmentation data for a sent or received message 1400 may be stored in the augmentation table 312.
Message duration parameter 1414: parameter value indicating, in seconds, the amount of time for which content of the message (e.g., the message image payload 1406, message video payload 1408, message audio payload 1410) is to be presented or made accessible to a user via the interaction client 104.
Message geolocation parameter 1416: geolocation data (e.g., latitudinal and longitudinal coordinates) associated with the content payload of the message. Multiple message geolocation parameter 1416 values may be included in the payload, each of these parameter values being associated with respect to content items included in the content (e.g., a specific image within the message image payload 1406, or a specific video in the message video payload 1408).
Message story identifier 1418: identifier values identifying one or more content collections (e.g., “stories” identified in the collections table 318) with which a particular content item in the message image payload 1406 of the message 1400 is associated. For example, multiple images within the message image payload 1406 may each be associated with multiple content collections using identifier values.
Message tag 1420: each message 1400 may be tagged with multiple tags, each of which is indicative of the subject matter of content included in the message payload. For example, where a particular image included in the message image payload 1406 depicts an animal (e.g., a lion), a tag value may be included within the message tag 1420 that is indicative of the relevant animal. Tag values may be generated manually, based on user input, or may be automatically generated using, for example, image recognition.
Message sender identifier 1422: an identifier (e.g., a messaging system identifier, email address, or device identifier) indicative of a user of the user system 102 on which the message 1400 was generated and from which the message 1400 was sent.
Message receiver identifier 1424: an identifier (e.g., a messaging system identifier, email address, or device identifier) indicative of a user of the user system 102 to which the message 1400 is addressed.

The contents (e.g., values) of the various components of message 1400 may be pointers to locations in tables within which content data values are stored. For example, an image value in the message image payload 1406 may be a pointer to (or address of) a location within an image table 316. Similarly, values within the message video payload 1408 may point to data stored within an image or video table 316, values stored within the message augmentation data 1412 may point to data stored in an augmentation table 312, values stored within the message story identifier 1418 may point to data stored in a collections table 318, and values stored within the message sender identifier 1422 and the message receiver identifier 1424 may point to user records stored within an entity table 308.

System with Head-Wearable Apparatus

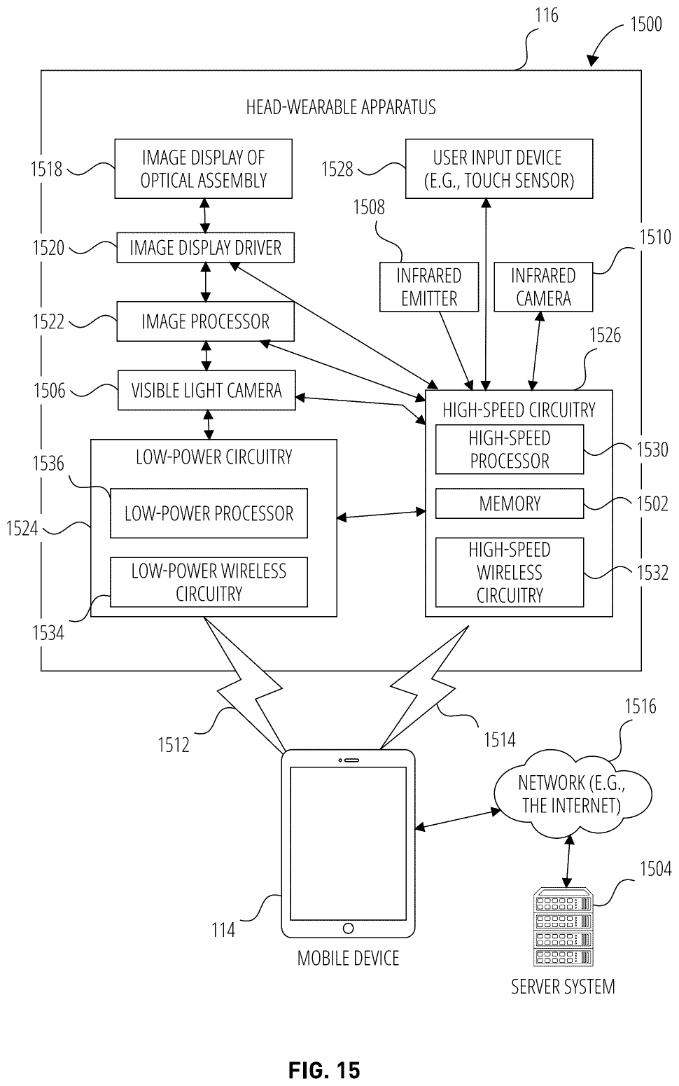

FIG. 15 illustrates a system 1500 including a head-wearable apparatus 116 with a selector input device, according to some examples. FIG. 15 is a high-level functional block diagram of an example head-wearable apparatus 116 communicatively coupled to a mobile device 114 and various server systems 1504 (e.g., the interaction server system 110) via various networks 108. The networks 108 may include any combination of wired and wireless connections.

The head-wearable apparatus 116 includes one or more cameras, each of which may be, for example, a visible light camera 1506, an infrared emitter 1508, and an infrared camera 1510.

An interaction client, such as a mobile device 114 connects with head-wearable apparatus 116 using both a low-power wireless connection 1512 and a high-speed wireless connection 1514. The mobile device 114 is also connected to the server system 1504 and the network 1516.

The head-wearable apparatus 116 further includes two image displays of the image display of optical assembly 1518. The two image displays of optical assembly 15 18 include one associated with the left lateral side and one associated with the right lateral side of the head-wearable apparatus 116. The head-wearable apparatus 116 also includes an image display driver 1520, an image processor 1522, low-power circuitry 1524, and high-speed circuitry 1526. The image display of optical assembly 1518 is for presenting images and videos, including an image that can include a graphical user interface to a user of the head-wearable apparatus 116.

The image display driver 1520 commands and controls the image display of optical assembly 1518. The image display driver 1520 may deliver image data directly to the image display of optical assembly 1518 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1528 (e.g., touch sensor or push button), including an input surface on the head-wearable apparatus 116. The user input device 1528 (e.g., touch sensor or push button) is to receive from the user an input selection to manipulate the graphical user interface of the presented image.

The components shown in FIG. 15 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1506 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1502, which stores instructions to perform a subset or all of the functions described herein. The memory 1502 can also include storage device.

As shown in FIG. 15, the high-speed circuitry 1526 includes a high-speed processor 1530, a memory 1502, and high-speed wireless circuitry 1532. In some examples, the image display driver 1520 is coupled to the high-speed circuitry 1526 and operated by the high-speed processor 1530 in order to drive the left and right image displays of the image display of optical assembly 1518. The high-speed processor 1530 may be any processor capable of managing high-speed communications and operation of any general computing system needed for the head-wearable apparatus 116. The high-speed processor 1530 includes processing resources needed for managing high-speed data transfers on a high-speed wireless connection 1514 to a wireless local area network (WLAN) using the high-speed wireless circuitry 1532. In certain examples, the high-speed processor 1530 executes an operating system such as a LINUX operating system or other such operating system of the head-wearable apparatus 116, and the operating system is stored in the memory 1502 for execution. In addition to any other responsibilities, the high-speed processor 1530 executing a software architecture for the head-wearable apparatus 116 is used to manage data transfers with high-speed wireless circuitry 1532. In certain examples, the high-speed wireless circuitry 1532 is configured to implement Institute of Electrical and Electronic Engineers (IEEE) 802.11 communication standards, also referred to herein as WI-FI®. In some examples, other high-speed communications standards may be implemented by the high-speed wireless circuitry 1532.

The low-power wireless circuitry 1534 and the high-speed wireless circuitry 1532 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 1512 and the high-speed wireless connection 1514, may be implemented using details of the architecture of the head-wearable apparatus 116, as can other elements of the network 1516.

The memory 1502 includes any storage device capable of storing various data and applications, including, among other things, camera data generated by the left and right visible light cameras 1506, the infrared camera 1510, and the image processor 1522, as well as images generated for display by the image display driver 1520 on the image displays of the image display of optical assembly 1518. While the memory 1502 is shown as integrated with high-speed circuitry 1526, in some examples, the memory 1502 may be an independent standalone element of the head-wearable apparatus 116. In certain such examples, electrical routing lines may provide a connection through a chip that includes the high-speed processor 1530 from the image processor 1522 or the low-power processor 1536 to the memory 1502. In some examples, the high-speed processor 1530 may manage addressing of the memory 1502 such that the low-power processor 1536 will boot the high-speed processor 1530 any time that a read or write operation involving memory 1502 is needed.

As shown in FIG. 15, the low-power processor 1536 or high-speed processor 1530 of the head-wearable apparatus 116 can be coupled to the camera (visible light camera 1506, infrared emitter 1508, or infrared camera 1510), the image display driver 1520, the user input device 1528 (e.g., touch sensor or push button), and the memory 1502.

The head-wearable apparatus 116 is connected to a host computer. For example, the head-wearable apparatus 116 is paired with the mobile device 114 via the high-speed wireless connection 1514 or connected to the server system 1504 via the network 1516. The server system 1504 may be one or more computing devices as part of a service or network computing system, for example, that includes a processor, a memory, and network communication interface to communicate over the network 1516 with the mobile device 114 and the head-wearable apparatus 116.

The mobile device 114 includes a processor and a network communication interface coupled to the processor. The network communication interface allows for communication over the network 1516, low-power wireless connection 1512, or high-speed wireless connection 1514. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1520. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1504, such as the user input device 1528, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1512 and high-speed wireless connection 1514 from the mobile device 114 via the low-power wireless circuitry 1534 or high-speed wireless circuitry 1532.

### Machine Architecture

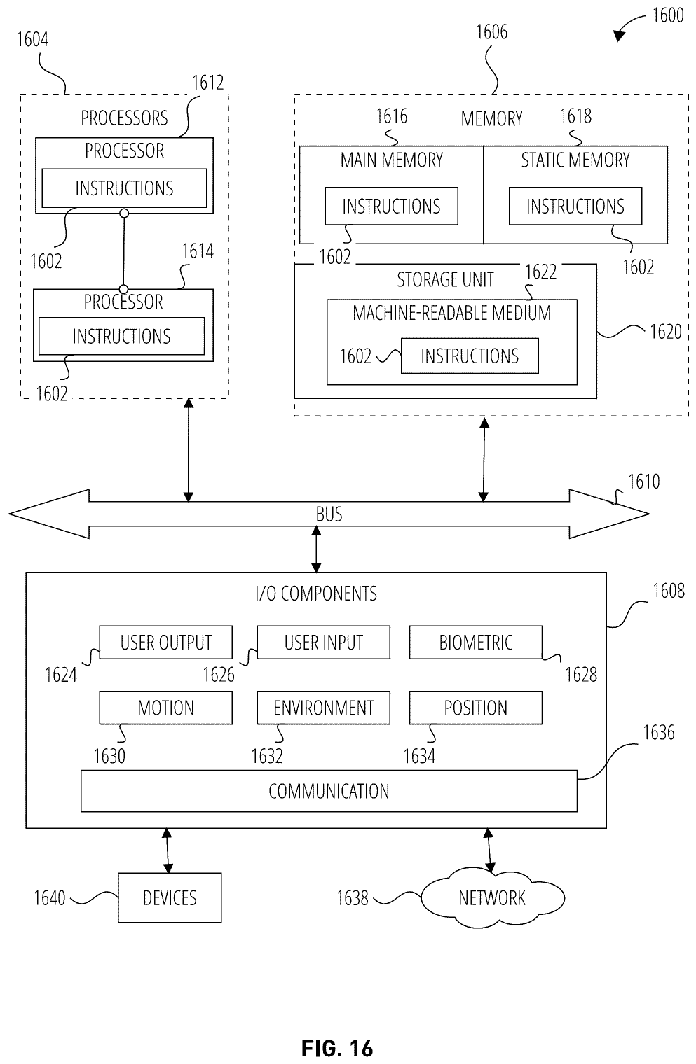

FIG. 16 is a diagrammatic representation of the machine 1600 within which instructions 1602 (e.g., software, a program, an application, an applet, an app, or other executable code) for causing the machine 1600 to perform any one or more of the methodologies discussed herein may be executed. For example, the instructions 1602 may cause the machine 1600 to execute any one or more of the methods described herein. The instructions 1602 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1602, sequentially or otherwise, that specify actions to be taken by the machine 1600. Further, while a single machine 1600 is illustrated, the term “machine” shall also be taken to include a collection of machines that individually or jointly execute the instructions 1602 to perform any one or more of the methodologies discussed herein. The machine 1600, for example, may comprise the user system 102 or any one of multiple server devices forming part of the interaction server system 110. In some examples, the machine 1600 may also comprise both client and server systems, with certain operations of a particular method or algorithm being performed on the server-side and with certain operations of the particular method or algorithm being performed on the client-side.

The machine 1600 may include processors 1604, memory 1606, and input/output I/O components 1608, which may be configured to communicate with each other via a bus 1610. In an example, the processors 1604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1612 and a processor 1614 that execute the instructions 1602. The term “processor” is intended to include multi-core processors that may comprise two or more independent processors (sometimes referred to as “cores”) that may execute instructions contemporaneously. Although FIG. 16 shows multiple processors 1604, the machine 1600 may include a single processor with a single-core, a single processor with multiple cores (e.g., a multi-core processor), multiple processors with a single core, multiple processors with multiples cores, or any combination thereof.

The memory 1606 includes a main memory 1616, a static memory 1618, and a storage unit 1620, both accessible to the processors 1604 via the bus 1610. The main memory 1606, the static memory 1618, and storage unit 1620 store the instructions 1602 embodying any one or more of the methodologies or functions described herein. The instructions 1602 may also reside, completely or partially, within the main memory 1616, within the static memory 1618, within machine-readable medium 1622 within the storage unit 1620, within at least one of the processors 1604 (e.g., within the processor's cache memory), or any suitable combination thereof, during execution thereof by the machine 1600.

The I/O components 1608 may include a wide variety of components to receive input, provide output, produce output, transmit information, exchange information, capture measurements, and so on. The specific I/O components 1608 that are included in a particular machine will depend on the type of machine. For example, portable machines such as mobile phones may include a touch input device or other such input mechanisms, while a headless server machine will likely not include such a touch input device. It will be appreciated that the I/O components 1608 may include many other components that are not shown in FIG. 16. In various examples, the I/O components 1608 may include user output components 1624 and user input components 1626. The user output components 1624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1608 may include biometric components 1628, motion components 1630, environmental components 1632, or position components 1634, among a wide array of other components. For example, the biometric components 1628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1630 include acceleration sensor components (e.g., accelerometer), gravitation sensor components, rotation sensor components (e.g., gyroscope).

The environmental components 1632 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1608 further include communication components 1636 operable to couple the machine 1600 to a network 1638 or devices 1640 via respective coupling or connections. For example, the communication components 1636 may include a network interface component or another suitable device to interface with the network 1638. In further examples, the communication components 1636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1640 may be another machine or any of a wide variety of peripheral devices (e.g., a peripheral device coupled via a USB).

Moreover, the communication components 1636 may detect identifiers or include components operable to detect identifiers. For example, the communication components 1636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1636, such as location via Internet Protocol (IP) geolocation, location via Wi-Fi® signal triangulation, location via detecting an NFC beacon signal that may indicate a particular location, and so forth.

The various memories (e.g., main memory 1616, static memory 1618, and memory of the processors 1604) and storage unit 1620 may store one or more sets of instructions and data structures (e.g., software) embodying or used by any one or more of the methodologies or functions described herein. These instructions (e.g., the instructions 1602), when executed by processors 1604, cause various operations to implement the disclosed examples.

The instructions 1602 may be transmitted or received over the network 1638, using a transmission medium, via a network interface device (e.g., a network interface component included in the communication components 1636) and using any one of several well-known transfer protocols (e.g., hypertext transfer protocol (HTTP)). Similarly, the instructions 1602 may be transmitted or received using a transmission medium via a coupling (e.g., a peer-to-peer coupling) to the devices 1640.

### Software Architecture

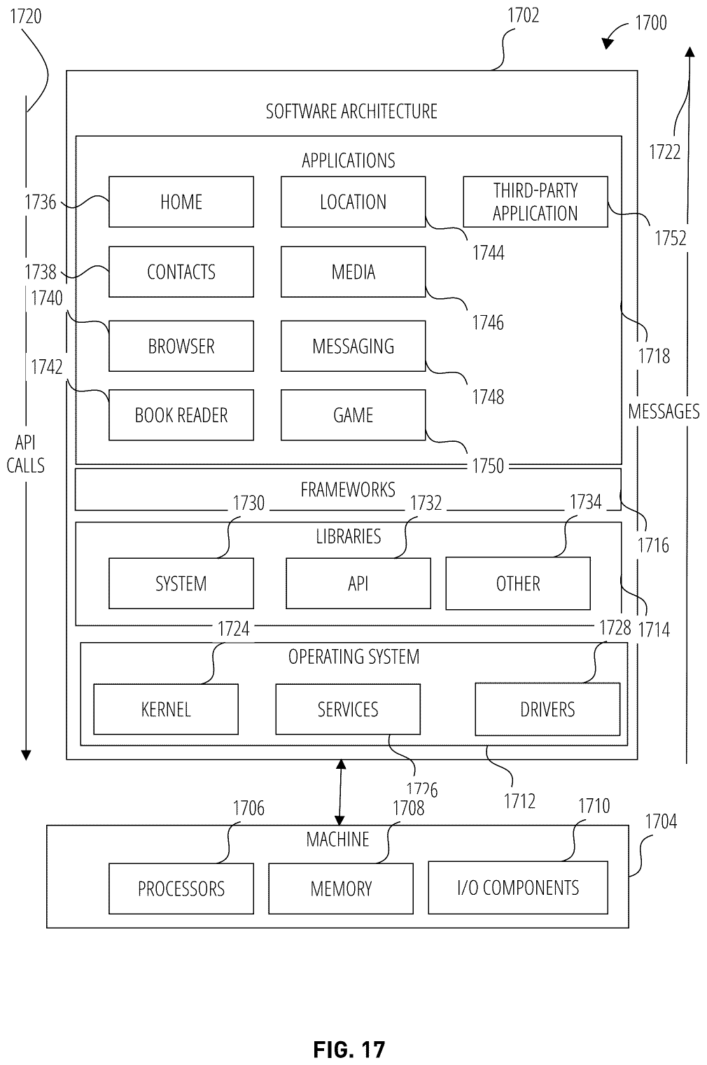

FIG. 17 is a block diagram 1700 illustrating a software architecture 1702, which can be installed on any one or more of the devices described herein. The software architecture 1702 is supported by hardware such as a machine 1704 that includes processors 1706, memory 1708, and I/O components 1710. In this example, the software architecture 1702 can be conceptualized as a stack of layers, where each layer provides a particular functionality. The software architecture 1702 includes layers such as an operating system 1712, libraries 1714, frameworks 1716, and applications 1718. Operationally, the applications 1718 invoke API calls 1720 through the software stack and receive messages 1722 in response to the API calls 1720.

The operating system 1712 manages hardware resources and provides common services. The operating system 1712 includes, for example, a kernel 1724, services 1726, and drivers 1728. The kernel 1724 acts as an abstraction layer between the hardware and the other software layers. For example, the kernel 1724 provides memory management, processor management (e.g., scheduling), component management, networking, and security settings, among other functionalities. The services 1726 can provide other common services for the other software layers. The drivers 1728 are responsible for controlling or interfacing with the underlying hardware. For instance, the drivers 1728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1714 provide a common low-level infrastructure used by the applications 1718. The libraries 1714 can include system libraries 1730 (e.g., C standard library) that provide functions such as memory allocation functions, string manipulation functions, mathematic functions, and the like. In addition, the libraries 1714 can include API libraries 1732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1714 can also include a wide variety of other libraries 1734 to provide many other APIs to the applications 1718.

The frameworks 1716 provide a common high-level infrastructure that is used by the applications 1718. For example, the frameworks 1716 provide various graphical user interface (GUI) functions, high-level resource management, and high-level location services. The frameworks 1716 can provide a broad spectrum of other APIs that can be used by the applications 1718, some of which may be specific to a particular operating system or platform.

In an example, the applications 1718 may include a home application 1736, a contacts application 1738, a browser application 1740, a book reader application 1742, a location application 1744, a media application 1746, a messaging application 1748, a game application 1750, and a broad assortment of other applications such as a third-party application 1752. The applications 1718 are programs that execute functions defined in the programs. Various programming languages can be employed to create one or more of the applications 1718, structured in a variety of manners, such as object-oriented programming languages (e.g., Objective-C, Java, or C++) or procedural programming languages (e.g., C or assembly language). In a specific example, the third-party application 1752 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1752 can invoke the API calls 1720 provided by the operating system 1712 to facilitate functionalities described herein.

### Machine-Learning Pipeline

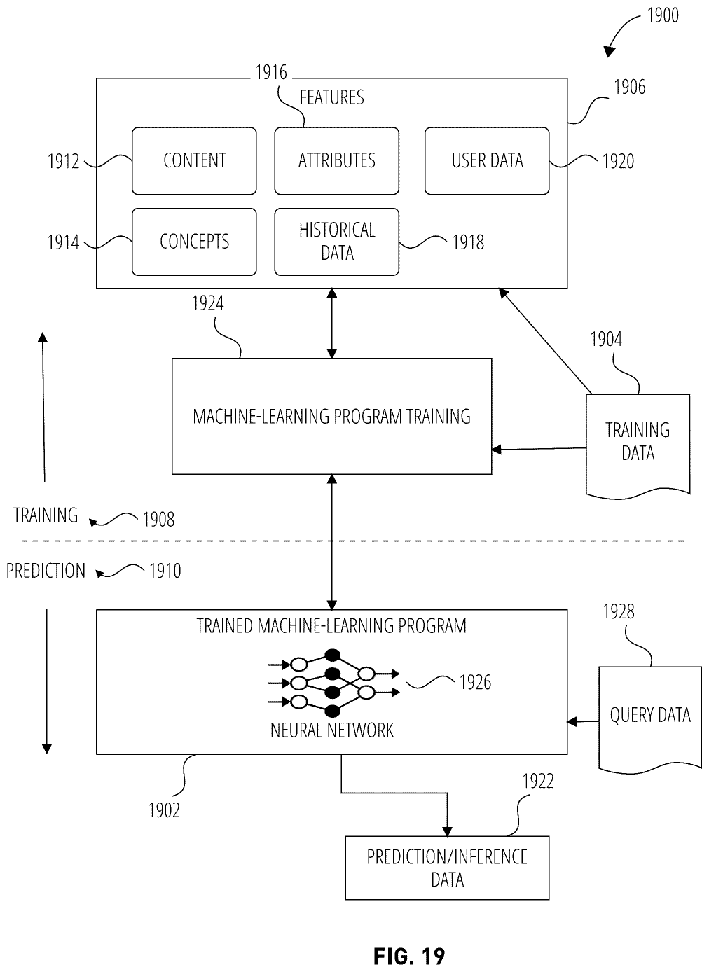

FIG. 19 is a flowchart depicting a machine-learning pipeline 1900, according to some examples. The machine-learning pipelines 1900 may be used to generate a trained model, for example the trained machine-learning program 1902 of FIG. 19, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

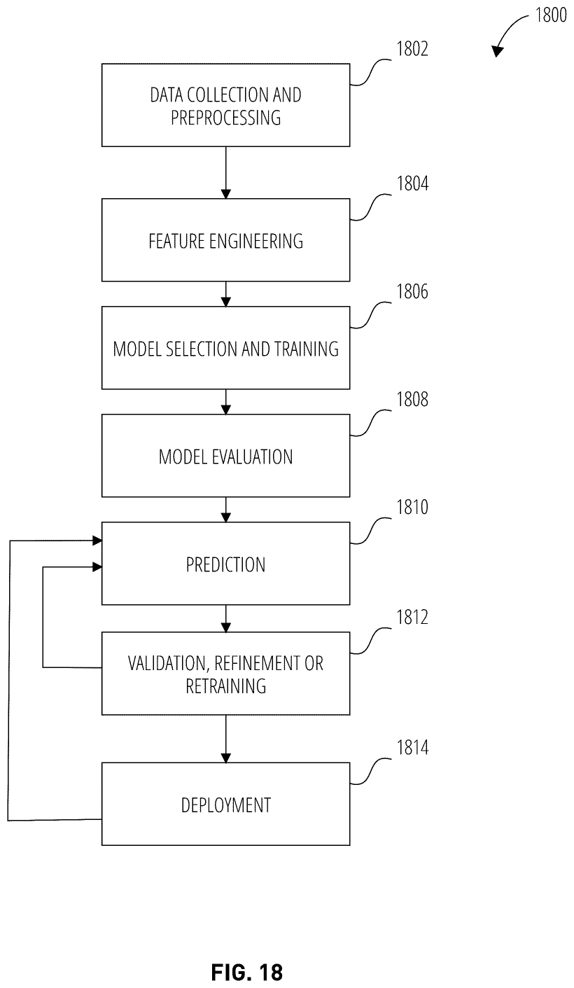

Generating a trained machine-learning program 1902 may include multiple types of phases that form part of the machine-learning pipeline 1900, including for example the following phases 1800 illustrated in FIG. 18:
Data collection and preprocessing 1802: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1804: This may include selecting and transforming the training data 1904 to create features that are useful for predicting the target variable. Feature engineering may include (1) receiving features 1906 (e.g., as structured or labeled data in supervised learning) and/or (2) identifying features 1906 (e.g., unstructured or unlabeled data for unsupervised learning) in training data 1904.
Model selection and training 1806: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1808: This may include evaluating the performance of a trained model (e.g., the trained machine-learning program 1902) on a separate testing dataset. This can help determine if the model is overfitting or underfitting and if it is suitable for deployment.
Prediction 1810: This involves using a trained model (e.g., trained machine-learning program 1902) to generate predictions on new, unseen data.
Validation, refinement or retraining 1812: This may include updating a model based on feedback generated from the prediction phase, such as new data or user feedback.
Deployment 1814: This may include integrating the trained model (e.g., the trained machine-learning program 1902) into a larger system or application, such as a web service, mobile app, or IoT device. This can involve setting up APIs, building a user interface, and ensuring that the model is scalable and can handle large volumes of data.

FIG. 19 illustrates two example phases, namely a training phase 1908 (part of the model selection and trainings 1806) and a prediction phase 1910 (part of prediction 1810). Prior to the training phase 1908, feature engineering 1804 is used to identify features 1906. This may include identifying informative, discriminating, and independent features for the effective operation of the trained machine-learning program 1902 in pattern recognition, classification, and regression. In some examples, the training data 1904 includes labeled data, which is known data for pre-identified features 1906 and one or more outcomes.

Each of the features 1906 may be a variable or attribute, such as individual measurable property of a process, article, system, or phenomenon represented by a data set (e.g., the training data 1904). Features 1906 may also be of different types, such as numeric features, strings, vectors, matrices, encodings, and graphs, and may include one or more of content 1912, concepts 1914, attributes 1916, historical data 1918 and/or user data 1920, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1908, the machine-learning pipeline 1900 uses the training data 1904 to find correlations among the features 1906 that affect a predicted outcome or prediction/inference data 1922.

With the training data 1904 and the identified features 1906, the trained machine-learning program 1902 is trained during the training phase 1908 during machine-learning program training 1924. The machine-learning program training 1924 appraises values of the features 1906 as they correlate to the training data 1904. The result of the training is the trained machine-learning program 1902 (e.g., a trained or learned model).

Further, the training phase 1908 may involve machine learning, in which the training data 1904 is structured (e.g., labeled during preprocessing operations), and the trained machine-learning program 1902 implements a relatively simple neural network 1926 capable of performing, for example, classification and clustering operations. In other examples, the training phase 1908 may involve deep learning, in which the training data 1904 is unstructured, and the trained machine-learning program 1902 implements a deep neural network 1926 that is able to perform both feature extraction and classification/clustering operations.

A neural network 1926 may, in some examples, be generated during the training phase 1908, and implemented within the trained machine-learning program 1902. The neural network 1926 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1926 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1926 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1908, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1926 is iteratively trained by adjusting model parameters to minimize a specific loss function or maximize a certain objective. The system can continue to train the neural network 1926 by adjusting parameters based on the output of the validation, refinement, or retraining block 1812, and rerun the prediction 1810 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1926 even after deployment 1814 of the neural network 1926. The neural network 1926 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1910, the trained machine-learning program 1902 uses the features 1906 for analyzing query data 1928 to generate inferences, outcomes, or predictions, as examples of a prediction/inference data 1922. For example, during prediction phase 1910, the trained machine-learning program 1902 is used to generate an output. Query data 1928 is provided as an input to the trained machine-learning program 1902, and the trained machine-learning program 1902 generates the prediction/inference data 1922 as output, responsive to receipt of the query data 1928. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1902 may be a generative AI model. Generative AI is a term that may refer to any type of artificial intelligence that can create new content from training data 1904. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1922 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
identifying a current location of a user that is initiating an interaction function of an interaction client;
identifying a map corresponding to the current location of the user;
identifying one or more map tiles associated with the map;
receiving historical location data of the user that is associated with the current location of the user;
converting the historical location data into an overall polygon that is comprised of a plurality of polygons based on the identified one or more map tiles; and
displaying the map with the plurality of polygons on a user interface.

2. The system of claim 1, wherein identifying one or more map tiles associated with the map comprises identifying a single map tile for the current location of the user.

3. The system of claim 2, the operations further comprising:
identifying a plurality of sub-tiles associated with the current location of the user, the single map tile comprised of a set of sub-tiles, the plurality of sub-tiles being a subset of the set of sub-tiles, converting of the historical location data into the overall polygon is further based on the plurality of sub-tiles.

4. The system of claim 1, wherein the historical location data includes time-stamped records of the user's past locations in the historical location data.

5. The system of claim 1, wherein receiving the historical location data includes accessing records that are within a certain radius or bounding box around the current location of the user.

6. The system of claim 5, wherein the radius or bounding box is dynamically adjusted based on a zoom level of the map on the user interface.

7. The system of claim 1, wherein receiving the historical location data includes accessing location data from user interaction of a plurality of interaction functions of the interaction client.

8. The system of claim 1, wherein receiving the historical location data includes accessing location data from user interaction on a plurality of interaction clients via the same application installed across the plurality of interaction clients.

9. The system of claim 1, wherein receiving the historical location data includes accessing one or more third party data sources that track and store geographic location information of the user.

10. The system of claim 1, the operations further comprising:
identifying individual historical location data points of the historical location data; and
adds a polygon to each of the individual historical location data points that correspond to a particular tile.

11. The system of claim 1, wherein each of the plurality of polygons includes a circle, wherein the overall polygon is not in a shape of a circle.

12. The system of claim 1, wherein the map tiles overlap with each other, and the plurality of polygons that are adjacent to each other overlap with one another.

13. The system of claim 1, the operations further comprise smoothing the edges of the plurality of polygons to generate the overall polygon.

14. The system of claim 1, the operations further comprising receiving a particular time frame from a user, and converting the historical location data into the overall polygon for locations that the user has visited during that particular time frame.

15. The system of claim 1, the operations further comprising receiving a particular geographical area from a user, and converting the historical location data into the overall polygon for locations that the user has visited within the particular geographical area.

16. The system of claim 1, the operations further comprise:
displaying the map with avatars of other users; and
in response to a user selection of another user's avatar, displaying the overall polygon corresponding to the other user.

17. The system of claim 1, the operations further comprise:
displaying a statistic indicating a relationship between the area visited by the user as compared with the total area of the displayed map; and
in response to a zoom in or out on the displayed map, updating the statistic to reflect the changed total area of the displayed map.

18. The system of claim 1, the operations further comprise:
identifying an overall polygon for another user; and
based on the overall polygon for the user and the overall polygon for the other user, provide a recommendation to the user that is associated with the other user.

19. A method comprising:
identifying a current location of a user that is initiating an interaction function of an interaction client;
identifying a map corresponding to the current location of the user;
identifying one or more map tiles associated with the map;
receiving historical location data of the user that is associated with the current location of the user;
converting the historical location data into an overall polygon that is comprised of a plurality of polygons based on the identified one or more map tiles; and
displaying the map with the plurality of polygons on a user interface.

20. A non-transitory computer-readable storage medium storing instructions that, when executed by at least one processor, cause the at least one processor to perform operations comprising:
identifying a current location of a user that is initiating an interaction function of an interaction client;
identifying a map corresponding to the current location of the user;
identifying one or more map tiles associated with the map;
receiving historical location data of the user that is associated with the current location of the user;
converting the historical location data into an overall polygon that is comprised of a plurality of polygons based on the identified one or more map tiles; and
displaying the map with the plurality of polygons on a user interface.
